(19) United States
(12) Patent Application Publication
(10) Pub. No.: US 2017/0185185 A1
(43) Pub. Date: Jun. 29, 2017

(54) TOUCH PANEL, METHOD OF MANUFACTURING THE SAME, AND DISPLAY DEVICE HAVING THE SAME

(71) Applicant: SAMSUNG DISPLAY CO., LTD., Yongin-si (KR)

(72) Inventors: Youngseok Yoo, Suwon-si (KR); Jeongheon Lee, Seongnam-si (KR); Sunghwan Kim, Ulsan (KR); Heewoong Park, Hwaseong-si (KR); Kangwon Lee, Seoul (KR); Youngsik Kim, Cheonan-si (KR); Innam Lee, Yongin-si (KR)

(21) Appl. No.: 15/229,021

(22) Filed: Aug. 4, 2016

(30) Foreign Application Priority Data
Dec. 29, 2015 (KR) 10-2015-0188801

(51) Int. Cl. G06F 3/044; G06F 3/045

(52) U.S. Cl. CPC G06F 3/044; G06F 3/045; G06F 2203/04107; G06F 2203/04103; G06F 2203/04111

(57) ABSTRACT

A touch panel includes a substrate, touch electrodes on the substrate and arranged along one direction, and an upper buffer member on the substrate and including a first buffer part overlapping the touch electrodes along the one direction, and a second buffer part between the touch electrodes.

### CROSS-REFERENCE TO RELATED APPLICATION

This U.S. non-provisional patent application claims priority to, and the benefit of, Korean Patent Application No. 10-2015-0188801, filed on Dec. 29, 2015, the contents of which are hereby incorporated by reference.

### BACKGROUND

1. Field of Disclosure

The present disclosure relates to a touch panel having improved impact resistance, a method of manufacturing the touch panel, and a display device having the touch panel.

2. Description of the Related Art

A touch panel serves as an input device of a display device that is commonly used for automated teller machines (ATMs), a navigation unit, a mobile phone, etc. When a user controls the touch panel using a stylus pen and/or one or more fingers, a voltage or current signal is generated corresponding to a position at which a touch event occurs, and then a command or graphic information specified by the user may be input through the touch panel.

The touch panel may be classified into one of a resistive overlay type touch panel, a capacitive overlay type touch panel, a surface acoustic wave type touch panel, or an infrared type touch panel, as determined by sensors of the touch panel. In recent years, the resistive overlay type touch panel or the capacitive overlay type touch panel, which is formed with a liquid crystal panel among flat panel display devices in one body, is widely used.

### SUMMARY

The present disclosure provides a touch panel having an improved impact resistance, a method of manufacturing the touch panel, and a display device having the touch panel.

Embodiments of the inventive concept provide a touch panel including a substrate, touch electrodes on the substrate and arranged along one direction, and an upper buffer member on the substrate and including a first buffer part overlapping the touch electrodes along the one direction, and a second buffer part between the touch electrodes.

The second buffer part may include a plurality of second buffer parts each extending from the first buffer part.

The first buffer part and the second buffer part may be spaced apart from each other.

The upper buffer member may include a polymer for absorbing an external impact.

The upper buffer member may include a dry film resist.

The touch panel may further include a polarizing plate having a lower surface attached to an upper surface of the upper buffer member by an adhesive member.

The touch panel may further include a lower buffer member under the substrate.

The touch panel may further include an insulation member, and a connection bridge contacting the first buffer part, wherein the touch electrodes may include first electrodes for sensing a touch signal, and second electrodes connected to each other by the connection bridge, and insulated from the first electrodes by the insulation member, the second electrodes for receiving the touch signal, and for applying the touch signal to a driving circuit.

Embodiments of the inventive concept provide a display device including a display panel for displaying an image, a touch panel on the display panel and including a substrate, touch electrodes arranged along one direction on the substrate, and an upper buffer member on the substrate and including a first buffer part overlapping the touch electrodes, and a second buffer part between the touch electrodes, and a window member on the touch panel.

The second buffer part may include a plurality of second buffer parts each extending from the first buffer part.

The first buffer part and the second buffer part may be spaced apart from each other.

The upper buffer member may include a polymer for absorbing an external impact.

The upper buffer member may include a dry film resist.

The touch panel may further include a polarizing plate having a lower surface attached to an upper surface of the upper buffer member by an adhesive member.

The touch panel may further include a lower buffer member between the substrate and the display panel.

Embodiments of the inventive concept provide a method of manufacturing a touch panel, the method including preparing a substrate, forming touch electrodes arranged along one direction on the substrate, and forming an upper buffer member including a first buffer part overlapping the touch electrodes, and a second buffer part between the touch electrodes.

The forming of the upper buffer member may include depositing a buffer material on the touch electrodes, and curing the buffer material.

The depositing of the buffer material may include depositing the buffer material between the touch electrodes.

According to the above, because the upper buffer member is on the touch electrodes and is cured, the upper buffer member absorbs impact from the upper portion of the polarizing plate. Therefore, cracking may be prevented from occurring in the touch electrodes and the connection bridge, and damage to the touch electrodes and the connection bridge may be reduced or prevented.

In addition, because the upper buffer member is between the adhesive member and the touch electrodes, erosion of the touch electrodes due to the contact between an acidic substance of the adhesive member and the touch electrodes may be reduced or prevented.

### BRIEF DESCRIPTION OF THE DRAWINGS

The above and other aspects of the present disclosure will become readily apparent by reference to the following detailed description when considered in conjunction with the accompanying drawings, wherein:

FIG. 1 is an exploded perspective view showing a display device according to an embodiment of the present disclosure;

FIG. 2A is a plan view showing a touch panel according to an embodiment of the present disclosure;

FIG. 2B is a cross-sectional view taken along the line A-A′ of FIG. 2A;

FIG. 2C is a cross-sectional view taken along the line B-B′ of FIG. 2A;

FIG. 3 is a cross-sectional view showing a touch panel according to another embodiment of the present disclosure;

FIG. 4 is a cross-sectional view showing a touch panel according to another embodiment of the present disclosure;

FIG. 5 is a flowchart showing a manufacturing method of the touch panel according to an embodiment of the present disclosure; and

FIGS. 6A to 6E are cross-sectional views sequentially showing the manufacturing method of the touch panel shown in FIG. 5.

### DETAILED DESCRIPTION

Features of the inventive concept and methods of accomplishing the same may be understood more readily by reference to the following detailed description of embodiments and the accompanying drawings. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. In addition, it will also be understood that when an element or layer is referred to as being “between” two elements or layers, it can be the only element or layer between the two elements or layers, or one or more intervening elements or layers may also be present.

In the following examples, the x-axis, the y-axis and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

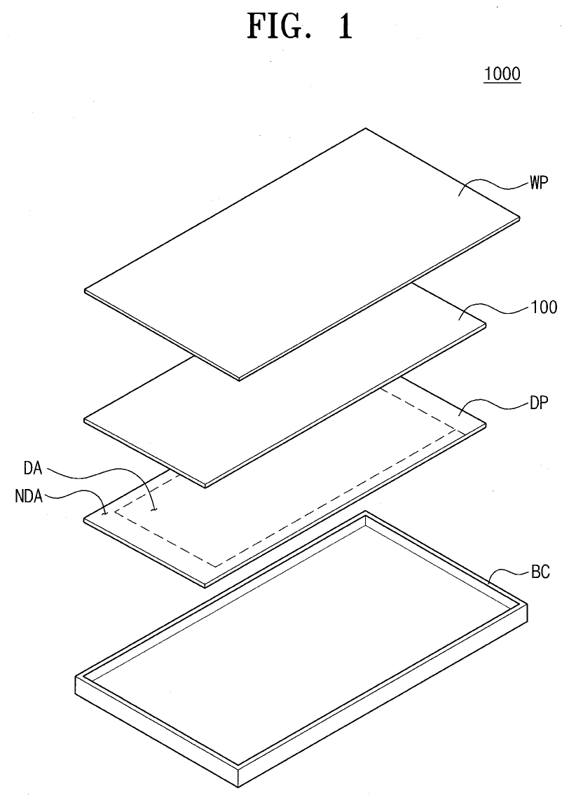

FIG. 1 is an exploded perspective view showing a display device 1000 according to an embodiment of the present disclosure.

Referring to FIG. 1, the display device 1000 includes a window member WP, a touch panel 100, a display panel DP, and a bottom chassis BC.

In the present embodiment, the window member WP is substantially plate shaped. The window member WP is substantially transparent. For instance, the window member WP may include glass or transparent polymer.

The window member WP is on the touch panel 100 to cover the touch panel 100, and to protect the touch panel 100 and the display panel DP from external impacts.

The touch panel 100 is substantially plate shaped. The touch panel 100 senses a contact with an external object or a hovering input, generates a touch signal, and applies the touch signal to a touch driver.

The display panel DP is under the touch panel 100. The display panel DP is substantially plate shaped in a manner similar to the touch panel 100. The display panel DP includes/defines a non-display area NDA and a display area DA. The display panel DP displays an image through the display area DA by using a source voltage and an image signal, which are applied thereto.

The bottom chassis BC is under the display panel DP. The bottom chassis BC includes/defines an accommodating space to accommodate the display panel DP in the accommodating space. The bottom chassis BC accommodates the display panel DP therein to absorb external impact, and thus the display panel DP is protected by the bottom chassis BC.

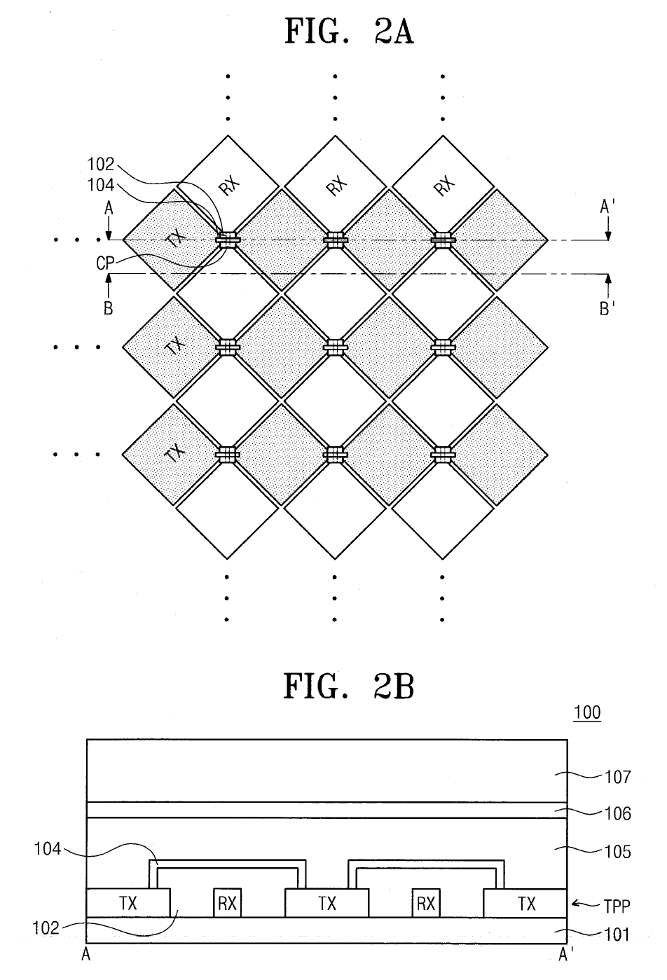

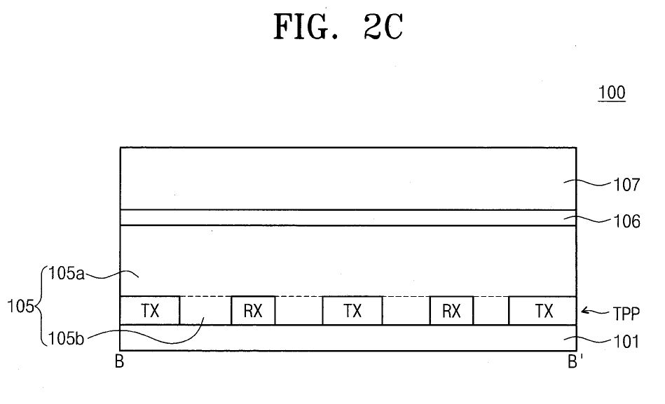

FIG. 2A is a plan view showing the touch panel according to an embodiment of the present disclosure, and FIG. 2B is a cross-sectional view taken along the line A-A′ of FIG. 2A.

Referring to FIGS. 2A and 2B, the touch panel 100 includes a substrate 101, touch electrodes TPP, an insulation member 102, a connection bridge 104, and an upper buffer member 105.

The substrate 101 is substantially plate shaped. The substrate 101 may include one or more materials selected from the groups consisting of polyethylene terephthalate (PET), cyclo-olefin polymer (COP), glass, and non-elongated polycarbonate, and the substrate 101 may be, but is not limited to, a low retardation film.

In the present embodiment, the touch panel 100 may be, but is not limited to, a capacitive overlay type touch panel. That is, the touch panel 100 may be a resistive overlay type touch panel in other embodiments. The capacitive overlay type may include a self-capacitance type or a mutual capacitance type.

The touch electrodes TPP are on the substrate 101. Also, the touch electrodes TPP are provided in a single-layer structure in the present embodiment, but they should not be limited thereto or thereby. The touch electrodes TPP may be provided in a multi-layer structure. The touch electrodes TPP include first electrodes RX and second electrodes TX.

The first electrodes RX are alternately arranged with the second electrodes TX on a plane surface/in a plan view. In more detail, the first electrodes RX and the second electrodes TX are arranged in a matrix configuration on the plane surface. The first electrodes RX and the second electrodes TX may include indium tin oxide (ITO), silver nanowire (AgNW), CNT, Metal Mesh, PEDOT, or Graphene.

The first electrodes RX may be, but are not limited to, electrodes for outputting a sensing signal, and the second electrodes TX may be, but are not limited to, electrodes for applying a driving signal to the touch driver.

In the present embodiment, each of the first electrodes RX and each of the second electrodes TX may have a lozenge shape, although the shape of the first electrodes RX and the second electrodes TX should not be limited thereto.

The first electrodes RX are electrically connected to each other, and the second electrodes TX are electrically connected to each other, and the first electrodes RX are insulated from the second electrodes TX.

More particularly, the first electrodes RX are insulated from the second electrodes TX by the insulation member 102. The insulation member 102 is between adjacent ones of the first electrodes RX and the second electrodes TX. The insulation member 102 includes an inorganic material.

The connection bridge 104 is on the insulation member 102. The connection bridge 104 includes a material having conductivity. For instance, the connection bridge 104 may include a metal material, such as molybdenum (Mo), silver (Ag), titanium (Ti), copper (Cu), aluminum (Al), etc. The connection bridge 104 may be provided in plural numbers as shown in FIG. 2B. As described earlier, the connection bridges 104 electrically connect second electrodes TX arranged in the same row among the second electrodes TX.

In the present embodiment, because corresponding ones of the first electrodes RX that are arranged in the same column are directly connected to each other through a connection part CP, these respective first electrodes RX are electrically connected to each other without using the connection bridges 104.

Both ends of the connection part CP are connected to the first electrodes RX. The connection part CP may include the same material as the first electrodes RX. The corresponding first electrodes RX that are arranged in the same column are formed with the connection part CP in one body (e.g., the corresponding first electrodes RX in the same column and the corresponding connection part CP may be integrally formed). Alternatively, in other embodiments, the first electrodes RX may be electrically connected to each other by a component that is similar to the connection bridge 104.

The upper buffer member 105 is on the touch electrodes TPP. Details on the upper buffer member 105 will be described later with reference to FIG. 2C.

A polarizing plate 107 may be substantially plate shaped. The polarizing plate 107 reduces or prevents an external light incident thereto from being perceived outside the touch panel 100 after the incident light is reflected. That is, the polarizing plate 107 reduces or prevents the external light incident thereto from exiting outside the touch panel 100 after being reflected. A lower surface of the polarizing plate 107 may be attached to an upper surface of the upper buffer member 105 by an adhesive member 106.

FIG. 2C is a cross-sectional view taken along the line B-B′ of FIG. 2A.

Referring to FIG. 2C, the upper buffer member 105 includes a first buffer part 105A and a second buffer part 105B. The first buffer part 105A is on the touch electrodes TPP. The second buffer part 105B is between the touch electrodes TPP.

More particularly, the touch electrodes TPP are arranged on the substrate 101 along one direction, and the second buffer part 105B overlaps the touch electrodes TPP along the one direction.

The second buffer part 105B may be provided in a plural number, and the second buffer parts 105B extend downward from the first buffer part 105A, and are located between the touch electrodes TPP.

The first buffer part 105A and the second buffer part 105B may include the same material. The first buffer part 105A and the second buffer part 105B may be formed in one body (e.g., formed as a unitary body of the same material). In detail, the first buffer part 105A and the second buffer part 105B may include a polymer. The first buffer part 105A and the second buffer part 105B may include an organic material.

Each of the first buffer part 105A and the second buffer part 105B may be, for example, a dry film resist. The dry film resist may be a photoresist film, and may include a material used to form circuit wires of a printed circuit board. The dry film resist has an excellent adhesive force and flatness. The dry film resist may be cured by exposure to a light.

The first buffer part 105A and the second buffer part 105B may include an insulating material to insulate the first electrodes RX from the second electrodes TX.

The upper buffer member 105 is on the touch electrodes TPP (e.g., after being cured). Therefore, the upper buffer member 105 absorbs impact provided from an upper portion of the polarizing plate 107 to reduce or prevent cracking of the touch electrodes TPP and the connection bridge 104 otherwise caused by external impacts, and thus damage/defect the touch electrodes TPP and the connection bridge 104 may be reduced or prevented.

In addition, because the upper buffer member 105 is between the adhesive member 106 and the touch electrodes TPP, erosion of the touch electrodes TPP due to the contact between an acidic substance of the adhesive member 106 and the touch electrodes TPP may be reduced or prevented.

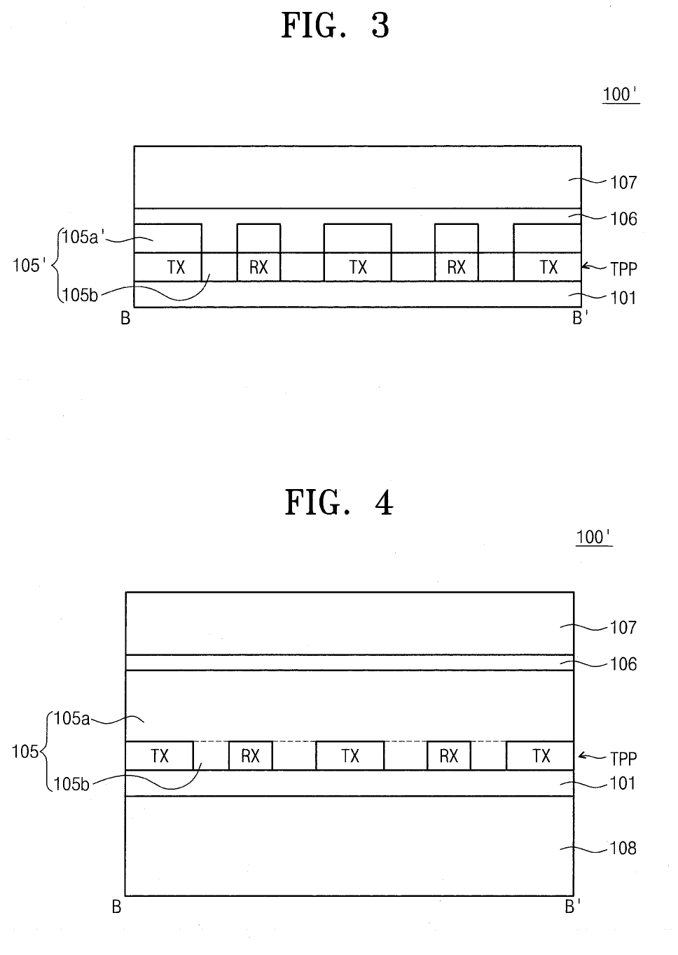

FIG. 3 is a cross-sectional view showing a touch panel 100′ according to another embodiment of the present disclosure.

Referring to FIG. 3, an upper buffer member 105′ includes a first buffer part 105A′ and the second buffer parts 105B. Unlike the touch panel 100 of the embodiment shown in FIG. 2C, the second buffer parts 105B of the present embodiment does not extend from the first buffer part 105A′ (e.g., is not formed as a single body with the first buffer part 105A′, and/or does not contact the first buffer part 105A′).

The first buffer part 105A′ may be provided in a plural number, and the first buffer parts 105A′ are spaced apart from each other. The first buffer parts 105A′ are respectively located on the touch electrodes TPP. Each of the first buffer parts 105A′ is spaced apart from the second buffer parts 105B. More particularly, each of the first buffer parts 105A′ of the present embodiment does not overlap the second buffer parts 105B in a vertical direction. Further, each of the first buffer parts 105A′ of the present embodiment might not overlap with the second buffer parts 105B in a horizontal direction.

Because detailed descriptions of the other components of the touch panel are described earlier with reference to FIG. 2C, details thereof will be omitted.

FIG. 4 is a cross-sectional view showing a touch panel 100″ according to another embodiment of the present disclosure.

When compared to the touch panel of the embodiment shown in FIG. 2C, the touch panel 100″ shown in FIG. 4 further includes a lower buffer member 108 under a substrate 101.

The lower buffer member 108 may include the same material as the upper buffer member 105. The lower buffer member 108 is substantially plate shaped, and contacts a lower surface of the substrate 101.

Because detailed descriptions of the other components of the touch panel 100 are described earlier with reference to FIG. 2C, details thereof will be omitted.

When the lower buffer member 108 is as described above, impacts provided from a set bracket engaged with a lower portion of the substrate 101 or the bottom chassis BC (refer to FIG. 1) may be reduced.

Consequently, similar to the upper buffer member 105 described with reference to the previous embodiment, the lower buffer member 108 absorbs external impacts to reduce or prevent damage to the touch electrodes TPP.

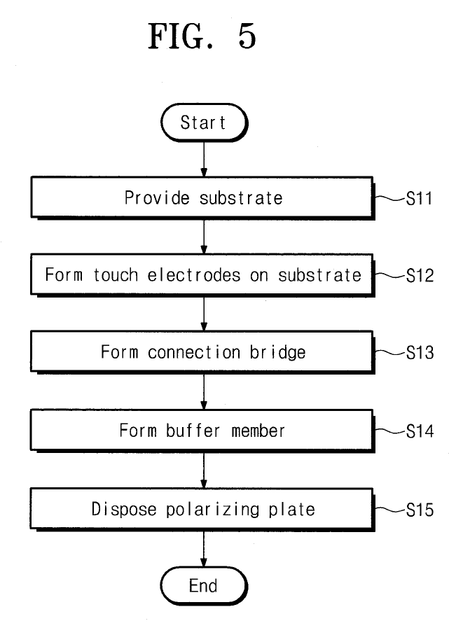

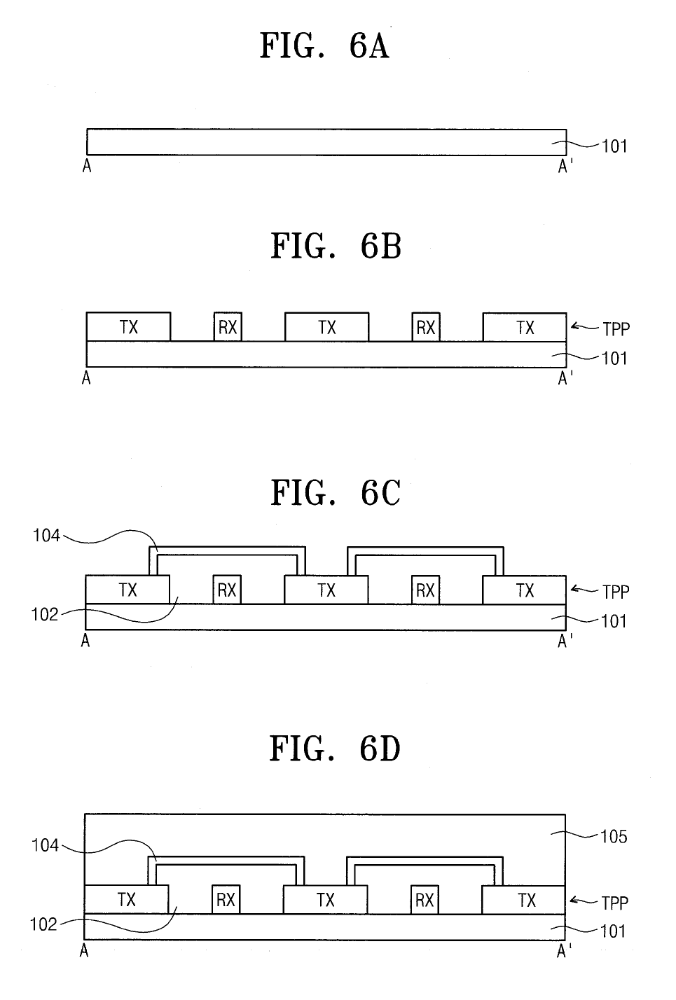

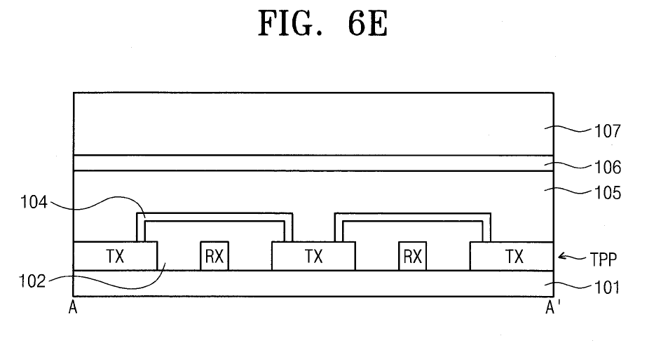

FIG. 5 is a flowchart showing a manufacturing method of the touch panel according to an embodiment of the present disclosure, and FIGS. 6A to 6E are cross-sectional views sequentially showing the manufacturing method of the touch panel shown in FIG. 5.

Referring to FIGS. 5 and 6A, the substrate 101 is provided (S11) to form the touch panel 100 described with reference to FIGS. 2A, 2B, and 2C.

When the substrate 101 is prepared, the touch electrodes TPP are formed on the substrate 101 (S12).

Referring to FIG. 6B, the touch electrodes TPP on the substrate 101 include the first electrodes RX and the second electrodes TX. Because detailed descriptions of the first and second electrodes RX and TX are described earlier, repeated details thereof will be omitted.

The first electrodes RX are alternately arranged with the second electrodes TX in one direction when viewed in a cross-sectional view. The first electrodes RX and the second electrodes TX are insulated from each other.

As an embodiment of the present disclosure, the touch electrodes TPP are formed by forming an indium tin oxide layer on the substrate 101, and by patterning the indium tin oxide layer through a photolithography process.

Then, the connection bridge 104 is formed to connect the second electrodes TX to each other (S13).

Referring to FIG. 6C, the insulation member 102 insulates the first electrodes RX from the second electrodes TX. The insulation member 102 fills a space between the first electrodes RX and the second electrodes TX. In addition, the insulation member 102 covers the first electrodes RX, and covers edges of the second electrodes TX adjacent the first electrodes RX.

A conductive layer is formed on the insulation member 102 and the second electrodes TX that are not covered by the insulation member 102, and the conductive layer is patterned to form the connection bridge 104. The connection bridge 104 is on the insulation member 102, and contacts the insulation member 102. Both ends of the connection bridge 104 are connected to respective ones of the second electrodes TX.

Referring to FIG. 6D, the upper buffer member 105 is formed on the touch electrodes TPP (S14).

The upper buffer member 105 is formed by depositing a buffer material on the touch electrodes TPP, and by curing the buffer material. As an embodiment of the present disclosure, the buffer material may be a polymer cured by exposure to light or heat.

Then, the polarizing plate 107 is formed on the upper buffer member 105 using the adhesive member 106 (S15).

Referring to FIG. 6E, the polarizing plate 107 is formed on the upper buffer member 105 using the adhesive member 106. More particularly, the lower surface of the polarizing plate 107 is attached to the upper surface of the upper buffer member 105 using the adhesive member 106, such that the polarizing plate 107 is located on the upper buffer member 105.

Although the embodiments of the present disclosure have been described, it is understood that the present disclosure should not be limited to these embodiments but various changes and modifications can be made by one ordinary skilled in the art within the spirit and scope of the present disclosure as hereinafter claimed by the following claims and their equivalents.

What is claimed is:

1. A touch panel comprising:
a substrate;
touch electrodes on the substrate and arranged along one direction; and
an upper buffer member on the substrate and comprising:
a first buffer part on the touch electrodes; and
a second buffer part between the touch electrodes overlapping the touch electrodes along the one direction

2. The touch panel of claim 1, wherein the second buffer part comprises a plurality of second buffer parts each extending from the first buffer part.

3. The touch panel of claim 1, wherein the first buffer part and the second buffer part are spaced apart from each other.

4. The touch panel of claim 1, wherein the upper buffer member comprises a polymer for absorbing an external impact.

5. The touch panel of claim 4, wherein the upper buffer member comprises a dry film resist.

6. The touch panel of claim 1, further comprising a polarizing plate having a lower surface attached to an upper surface of the upper buffer member by an adhesive member.

7. The touch panel of claim 1, further comprising a lower buffer member under the substrate.

8. The touch panel of claim 1, further comprising:
an insulation member; and
a connection bridge contacting the first buffer part,
wherein the touch electrodes comprise:
first electrodes for sensing a touch signal; and
second electrodes connected to each other by the connection bridge, and insulated from the first electrodes by the insulation member, the second electrodes for receiving the touch signal, and for applying the touch signal to a driving circuit.

9. A display device comprising:
a display panel for displaying an image;
a touch panel on the display panel and comprising:
a substrate;
touch electrodes arranged along one direction on the substrate; and
an upper buffer member on the substrate and comprising:
a first buffer part on the touch electrodes; and
a second buffer part between the touch electrodes overlapping the touch electrodes along the one direction; and
a window member on the touch panel.

10. The display device of claim 9, wherein the second buffer part comprises a plurality of second buffer parts each extending from the first buffer part.

11. The display device of claim 9, wherein the first buffer part and the second buffer part are spaced apart from each other.

12. The display device of claim 9, wherein the upper buffer member comprises a polymer for absorbing an external impact.

13. The display device of claim 12, wherein the upper buffer member comprises a dry film resist.

14. The display device of claim 9, wherein the touch panel further comprises a polarizing plate having a lower surface attached to an upper surface of the upper buffer member by an adhesive member.

15. The display device of claim 9, wherein the touch panel further comprises a lower buffer member between the substrate and the display panel.

16. A method of manufacturing a touch panel, the method comprising:
preparing a substrate;
forming touch electrodes arranged along one direction on the substrate; and
forming an upper buffer member comprising:
a first buffer part on the touch electrodes; and
a second buffer part between the touch electrodes overlapping the touch electrodes in the one direction

17. The method of claim 16, wherein the forming of the upper buffer member comprises:
depositing a buffer material on the touch electrodes; and
curing the buffer material.

18. The method of claim 17, wherein the depositing of the buffer material comprises depositing the buffer material between the touch electrodes.
